(19) United States
(12) Patent Application Publication
(10) Pub. No.: US 2023/0184298 A1
(43) Pub. Date: Jun. 15, 2023

(54) Torque Transmission Device

(71) Applicant: ZF FRIEDRICHSHAFEN AG, Friedrichshafen (DE)

(72) Inventors: Daniel ECKHARDT, Gochsheim (DE); Laura RÖDER, Prosselsheim (DE); Tobias AMENT, Sulzheim (DE); Vit PROSEK, Pilzen (CZ); Tobias DIECKHOFF, Würzburg (DE); Guntram LOOK, Grafenrheinfeld (DE); Kathrin MAYER, Frammersbach (DE); Martin PFEUFFER, Schweinfurt (DE)

(21) Appl. No.: 17/924,007

(22) PCT Filed: May 12, 2021
(86) PCT No.: PCT/EP2021/062600

§ 371 Date: Nov. 8, 2022

(30) Foreign Application Priority Data
May 18, 2020 (DE) 10 2020 206 189.0

(51) Int. Cl. F16D 7/02; F16D 3/12

(52) U.S. Cl. CPC F16D 7/025; F16D 3/12; F16D 2250/0084

(57) ABSTRACT

The invention relates to a torque transmission device (1) for the drive train of a motor vehicle, comprising an input element (2) and a cover element (16) which is connected to the input element (2) for conjoint rotation, and comprising an output element (3), wherein: the output element (3) and the input element (2) are rotatable in relation to one another via an energy accumulator device (4) and about a common axis of rotation A; a torque-limiting device (10) is located between the input element (2) and the output element (3); the torque-limiting device (10) is designed to transmit a torque between the input element (2) and the output element (3) up to a limit torque value and, when the limit torque value is exceeded, to transmit a torque at least in part or to transmit no torque at all; the torque-limiting device (10) is connected to the energy accumulator device (4) via a frictional and/or form-fitting connection (8), is connected to the input element (2) via a first frictional connection (9), and is connected to the cover element (16) via a second frictional connection (14); the torque-limiting device (10) comprises a preload element (5) for providing the frictional connections (9; 14); the preload element (5) is preloaded between the input element (2) and the cover element (16); a radially inner region of the preload element (5) is provided with at least two contact elements (17a, 17b, 17c, 17d, 17e, 17f); the contact elements (17a, 17b, 17c, 17d, 17e, 17f) are provided on a radius (r) and protrude axially out of the preload element (5) in the direction of the input element (2); the contact elements (17a, 17b, 17c, 17d, 17e, 17f) are at an angular distance (α) from one another; and the contact elements (17a, 17b, 17c, 17d, 17e, 17f) form the first frictional connection with the input element (2).

### CROSS REFERENCE TO RELATED APPLICATIONS

This is a U.S. national stage of Application No. PCT/EP2021/062600 filed May 12, 2021. Priority is claimed on German Application No. DE 10 2020 206 189.0 filed May 18, 2020 the content of which is incorporated herein by reference.

### BACKGROUND OF THE INVENTION

### 1. Field of the Invention

The disclosure relates to a torque transmission device, in particular for the drive train of a motor vehicle, comprising an input element and an output element, which are rotatable relative to one another via an energy storage device and about a joint axis of rotation, and wherein a torque-limiting device is arranged between input element and output element, wherein the torque-limiting device is formed to transmit a torque between input element and output element below a torque value and, above the torque value, to transmit at least partially, in particular completely no torque.

The disclosure furthermore relates to a method for producing a torque transmission device, in particular for the drive train of a motor vehicle, comprising:
providing an input element,
providing an output element,
providing an energy storage device,
providing a torque-limiting device, wherein the torque-limiting device is formed, below a torque value, to transmit a torque and, above the torque value, to at least partially transmit no torque,
providing a cover element,
arranging input element and output element rotatably relative to one another via the energy storage device and about a joint axis of rotation, and
arranging the torque-limiting device between input element and output element.

### 2. Description of Related Art

A torque transmission device is known from, for example, DE 10 2012 211 990 A1. The torque transmission device, in particular for a drive train of an internal combustion engine-driven motor vehicle, has in this case an input part and an output part with a joint axis of rotation about which the input part and the output part are jointly rotatable and are rotatable in a restricted manner relative to one another, at least one energy store which is active between the input part and the output part, which energy store is supported on one hand on the input part and on the other hand on the output part, and a torque-limiting device arranged kinematically between the at least one energy store and the input part or the output part, in the case of which the torque-limiting device has a supporting portion, on which the at least one energy store is supported and which bears against the input part or the output part in a positive-locking and frictional manner, and a spring portion, which brings about pretensioned bearing of the supporting portion against the input part or against the output part and in the case of a supporting force of the at least one energy store that exceeds a predefined value on the supporting portion with deflection enables a release of the supporting portion from the input part or from the output part.

The complex construction and the expensive production of the torque transmission device as well as the imprecise function of the torque-limiting device are, however, disadvantageous in this case.

### SUMMARY OF THE INVENTION

One aspect of the present invention is a torque transmission device that enables a limiting of torque peaks, is simultaneously easy to construct, can be produced at low cost, and functions in a reliable and precise manner

A further aspect of the present invention is to indicate an alternative torque transmission device and an alternative method for producing a torque transmission device.

One aspect of the present invention achieves the above-mentioned is a torque transmission device for the drive train of a motor vehicle, comprising an input element and a cover element, which is connected in a rotationally conjoint manner to the input element, as well as an output element, wherein the output element and the input element are rotatable relative to one another via an energy storage device and about a joint axis of rotation A and wherein a torque-limiting device is arranged between input element and output element, wherein the torque-limiting device is formed to transmit a torque between input element and output element up to a torque threshold value and, in the event of the torque threshold value being exceeded, to transmit at least partially torque or completely no torque, wherein the torque-limiting device is connected to the energy storage device via a frictional and/or positive-locking connection, and is connected to the input element via a first frictionally engaged connection and is connected to the cover element via a second frictionally engaged connection, wherein the torque-limiting device comprises an axially pretensioned element for providing the frictionally engaged connections, wherein the pretensioning element is pretensioned between the input element and the cover element, wherein the pretensioning element provides on a radially inner region at least two contact elements, wherein the contact elements are provided on a radius and project axially in the direction of the input element from the pretensioned element, wherein the contact elements are provided with an angular distance to one another and wherein the contact elements form the first frictionally engaged connection with the input element.

One aspect of the present invention is a method for producing a torque transmission device for the drive train of a motor vehicle, comprising
providing an input element,
providing an output element,
providing an energy storage device,
providing a torque-limiting device, wherein the torque-limiting device is formed, below a torque value, to transmit a torque between input element and output element and, above the torque value, to at least partially transmit no torque,
providing a cover element,
arranging input element and output element rotatably relative to one another via the energy storage device and about a joint axis of rotation A,
arranging the torque-limiting device between input element and output element, wherein the torque-limiting device is formed, below a torque value, to transmit a torque between input element and output element and, above the torque value, to at least partially transmit no torque,
arranging the cover element so that the torque limiting device is clamped between the input element and the cover element with a defined clamping force, wherein in the presence of the defined clamping force the cover element is connected in a rotationally conjoint and axially fixed manner to the input element so that the torque-limiting device transmits the torque between the input element and the output element up to a threshold torque and, in the event of the threshold torque being exceeded, only partially or even no torque is transmitted.

One of the advantages achieved thereby is that simple and low-cost production and construction are enabled. An alternative torque transmission device and a method for producing a torque transmission device are furthermore indicated.

Further features, advantages and further aspects of the invention are described below and or inherent as a result of this.

It can furthermore be provided that the contact elements are formed from the pretensioned element and/or are provided as additional elements to the pretensioning element. The pretensioning element can preferably be produced from a resilient material such as spring steel sheet. The pretensioning element is embodied to be L-shaped as seen in cross-section. This form can preferably be performed by a reshaping process. In the case of this reshaping process, it can equally also be provided that the contact elements are also formed from the spring steel sheet. The contact elements can, however, also be subsequently attached to the pretensioning element as an additional part.

The axial pretensioning element can also provide a radial centering surface radially on the inside and wherein the input element provides at least three corresponding radial bearing elements distributed evenly over the circumference. Three bearing elements distributed evenly over the circumference are particularly well suited to radial centering. Since the torque transmission device provides a viscous medium for lubrication, the viscous medium can reach particularly effectively between the radial centering surface of the pretensioned element and the bearing elements since the centering surface is not continuous but is interrupted by the individually provided bearing elements on the circumference and thus the viscous medium can always reach the radial centering surface again.

In this case, the radial bearing elements can be formed from the input element and/or be attached to the input element as additional elements.

It will be obvious that the above-mentioned features and the features which are still to be explained below can not only be used in the respectively indicated combination, but also in other combinations or on their own without departing from the scope of the present invention.

Preferred designs and embodiments of the present invention are represented in the drawings and are explained in greater detail in the following description, wherein identical reference numbers refer to identical or similar or functionally identical components or elements.

### BRIEF DESCRIPTION OF THE DRAWINGS

FIG. 1 is, in cross-section, a torque transmission device;

FIG. 2 is a cut-out in the region of the contact elements;

FIG. 3 is a cut-out in the region of the connection input element and cover element;

FIG. 4 is a plan view of the pretensioning element with contact elements;

FIG. 5 is, like FIG. 1, only in terms of the adjustment of the pretensioning force of the pretensioned element; and

FIG. 6 is a method of the present invention.

### DETAILED DESCRIPTION OF THE PRESENTLY PREFERRED EMBODIMENTS

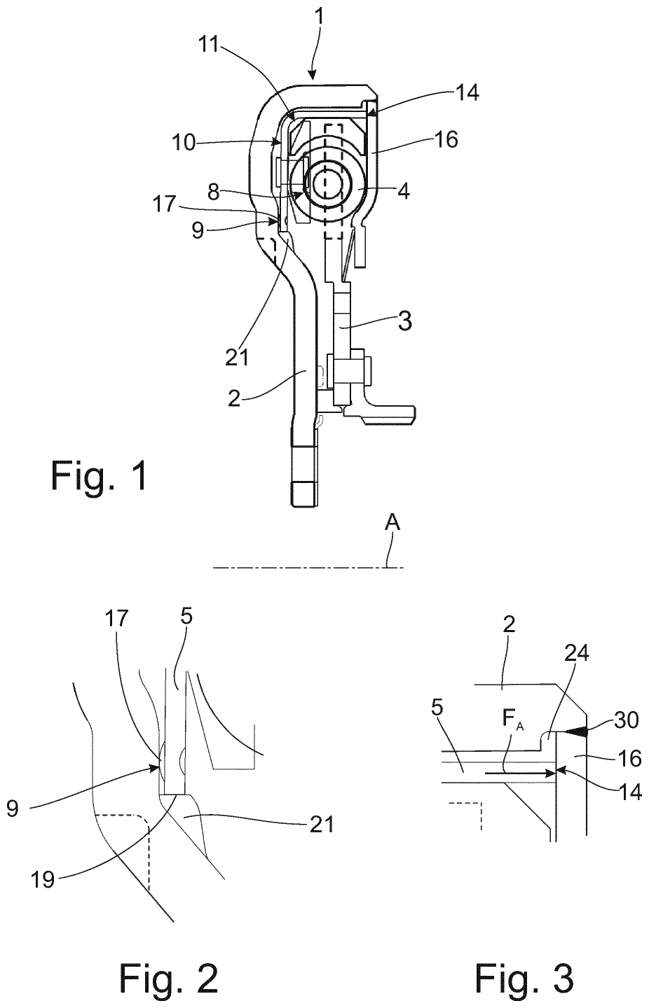

FIG. 1 shows, in cross section, a torque transmission device according to one aspect of the present invention.

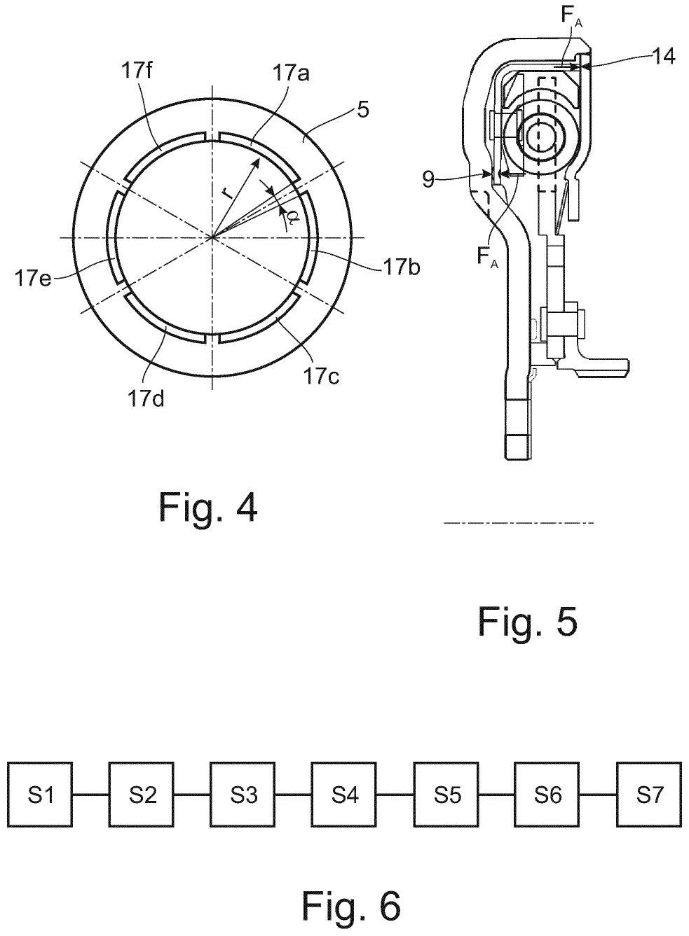

FIG. 1 shows in detail a torque transmission device 1 in the form of a torsion damper with an input part 2 in the form of a primary flywheel and an output part 3 stated here in the form 5 of a hub plate. The primary flywheel 2 and the hub plate 3 are rotatable relative to one another via an energy storage device 4 and about a joint axis of rotation A. A torque-limiting device 10 is furthermore arranged between primary flywheel 2 and energy storage device 4, wherein the torque-limiting device 10 is formed to transmit the torque between primary flywheel 2 and hub wheel 2 until a threshold torque is reached and, in the event of the threshold torque being exceeded, to at least partially transmit no torque. The torque-limiting device 10 has an axially pretensioned, substantially pot-shaped element 5 clamped in a frictionally engaged manner by an axial pretensioning FA between the input element 2 and the cover element 16. In this case, contact elements 17, here five of them with the numbers 17a, 17b, 17c, 17d, 17e, 17f, are provided here on the pretensioning element 5, here with reference already to FIGS. 2 and 4, distributed evenly over the circumference. These contact elements 17a, 17b, 17c, 17d, 17e, 17f form a first frictionally engaged connection 9 to the input element 2. Here, the contact elements 17a, 17b, 17c, 17d, 17e, 17f are formed by a reshaping process from the actual pretensioning element 5. A second frictionally engaged connection 14 is formed with the cover element 16 on a radially outer region of the pretensioning element 5. A radial centering surface 19 running over the circumference is provided radially on the inside on the pretensioning element 5, which radial centering surface 19 is radially centered on corresponding radial bearing elements 21 of the input element 2. In this case, a torque is transmitted between the input element 2 and the output element 3 in this manner below a predefinable maximum torque, for example, by selection of the materials and/or the axial pretensioning. Above the predefinable torque, the frictionally engaged connection provided by the axial pretensioning is released, only a small amount of or no torque is introduced any more into the energy storage device 4. As a result of this, damage to the torque transmission device 1 and also furthermore in the downstream drive train can be avoided.

The pretensioning element 5 is in this case axially pretensioned by a cover element 16 which form on the output side next to the primary flywheel 2 a torus-shaped intermediate space 11 for the energy storage device 4 arranged in the circumferential direction. The pretensioning element 5 furthermore provides a frictional and/or positive-locking connection 8 in order to actuate the energy store 4.

FIG. 2 shows a cut-out in the region of the contact elements. It is clearly apparent here that here the contact element 17 was formed from the pretensioning element 5 and with the input element 2 form the first frictionally engaged connection. The radial centering surface 19 which is directed towards the radial bearing elements 21 is also clearly apparent here.

FIG. 3 shows a cut-out in the region of the connection of the input element 3 and the cover element 16. It should be mentioned in this case that a collar 24, which extends axially is provided on the input element 3. If the pretensioning element 5, with reference to FIG. 1, is now pretensioned during mounting between the input element 2 and the cover element 16, the cover element 16 can be displaced in the axial direction along the collar 24. As a result of this, a precisely defined pretensioning force FA can be adjusted. This is particularly important for the actual function of the slipping through of the pretensioning element 5. If the desired pretensioning force FA is reached, the cover element 16 is advantageously connected by a weld seam 30 to the input element.

FIG. 4 shows a plan view of the pretensioning element 5 with the contact elements 17a, 17b, 17c, 17d, 17e, 17f. In this case, 6 contact elements are arranged distributed evenly over the circumference. A distance with an angle a is provided between the contact elements 17a, 17b, 17c, 17d, 17e, 17f. This means that the contact between the contact elements 17a, 17b, 17c, 17d, 17e, 17f and the input element 2 is not continuous, but rather is interrupted. As a result of this, an existing viscous medium can settle therebetween and ensure a durable function of the slipping through in the event of a threshold torque being exceeded. It should be mentioned here that the number of contact elements can vary and that also the distance between the contact elements can be uneven.

FIG. 5 shows a representation like FIG. 1, only in terms of the adjustment of the pretensioning force FA of the pretensioning element 5. As a result of action equals reaction, the same pretensioning force FA arises at the first frictionally engaged connection 9 as at the second frictionally engaged connection 14.

FIG. 6 shows steps of a method according to one embodiment of the preceding invention.

The method comprises:

In a first step S1, an input element is provided.

In a further step S2, an output element is provided.

In a further step S3, an energy storage device is provided.

In a further step S4, a torque-limiting device is provided, wherein the torque-limiting device is formed to transmit a torque up to a torque threshold value and, in the event if the torque threshold value being exceeded, to at least partially or completely transmit no torque.

In a further step S5, the cover element is provided.

In a further step S6, input element and output element are arranged rotatably relative to one another via the energy storage device and about a joint axis of rotation.

In a further step S7, the torque-limiting device is arranged between input element and output element.

In steps S1-S7, the torque-limiting device is connected to the energy storage device via a frictional and/or positive-locking connection and is connected to the input element via a frictionally engaged connection.

In summary, at least one of the aspects of the invention has at least one of the following advantages:
Simple production
Low-cost production
Simple construction
Reliable torque limiting and transmission

Although the present invention has been described on the basis of preferred exemplary embodiments, it is not restricted thereto, but rather can be modified in various ways.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-5. (canceled)

6. A torque transmission device for a drive train of a motor vehicle, comprising:
an input element;
an output element;
a cover element connected in a rotationally conjoint manner to the input element, as well as the output element;
an energy storage device via which the output element and the input element are rotatable relative to one another about a joint axis of rotation A;
a torque-limiting device is arranged between the input element and the output element, and configured to transmit a torque between the input element and the output element up to a torque threshold value and, when the torque threshold value being exceeded, to transmit at least partially a torque or completely no torque;
a frictional and/or positive-locking connection via which the torque-limiting device is connected to the energy storage device;
a first frictionally engaged connection via which the torque-limiting device is connected to the input element; and
a second frictionally engaged connection via which the torque-limiting device is connected to the cover element;
wherein the torque-limiting device comprises a pretensioning element configured to provide the first and second frictionally engaged connections, wherein the pretensioning element is pretensioned between the input element and the cover element,
wherein the pretensioning element on a radially inner region has at least two contact elements,
wherein the at least two contact elements are provided on a radius and project axially in a direction of the input element from the pretensioning element, and
wherein the at least two contact elements are provided with an angular distance to one another and wherein the at least two contact elements form the first frictionally engaged connection with the input element.

7. The torque transmission device as claimed in claim 6, wherein the at least two contact elements are formed from the pretensioned element and/or are provided as additional elements to the pretensioning element.

8. The torque transmission device as claimed in claim 6, wherein the axial pretensioning element provides a radial centering surface radially on an inside and wherein the input element provides at least three corresponding radial bearing elements distributed evenly over a circumference.

9. The torque transmission device as claimed in claim 8, wherein the radial bearing elements are formed from the input element and/or are attached as additional elements to the input element.

10. A method for producing a torque transmission device, for a drive train of a motor vehicle, comprising:
providing an input element;
providing an output element;
providing an energy storage device;
providing a torque-limiting device, wherein the torque-limiting device is configured, below a torque value, to transmit a torque between input element and output element and, above the torque value, to at least partially transmit no torque;
providing a cover element;
arranging the input element and the output element rotatably relative to one another via the energy storage device and about a joint axis of rotation A;
arranging the torque-limiting device between the input element and the output element, wherein the torque-limiting device is formed, below a torque value, to transmit a torque between input element and output element and, above the torque value, to at least partially transmit no torque; and
arranging the cover element so that the torque-limiting device is clamped between the input element and the cover element with a defined clamping force;
wherein in presence of the defined clamping force, the cover element is connected in a rotationally conjoint and axially fixed manner to the input element so that the torque-limiting device transmits the torque between the input element and the output element up to a threshold torque and, in event of the threshold torque being exceeded, only partially or even no torque is transmitted.
